(19) United States
(12) Patent Application Publication
(10) Pub. No.: US 2019/0359815 A1
(43) Pub. Date: Nov. 28, 2019

(54) TOLERANCE COMPENSATION COMPOSITION AND SEALANT

(71) Applicant: AIRBUS OPERATIONS GMBH, Hamburg (DE)

(72) Inventors: Thorsten ROYE, Dollern (DE); Thomas SCHÖNBECK, Stade (DE)

(21) Appl. No.: 16/205,722

(22) Filed: Nov. 30, 2018

(30) Foreign Application Priority Data
Nov. 30, 2017 (DE) 20 2017 107 320.3

(51) Int. Cl. C08L 63/00; C08J 5/04; C08J 5/12

(52) U.S. Cl. CPC C08L 63/00; C08J 5/124; C08J 5/042

(57) ABSTRACT

A curable material is disclosed for simultaneous filling of tolerances and for sealing of components to be bonded in aircraft construction.

The curable material can be made of fiber-reinforced plastic (CFRP). The curable material enables simultaneous structural adhesive bonding. The curable material can be based on two-component epoxy resin.

### CROSS-REFERENCE TO RELATED APPLICATION

This application claims priority to German Patent Application No. 20 2017 107 320.3 filed Nov. 30, 2017, the entire disclosure of which is incorporated by reference herein.

### TECHNICAL FIELD

The disclosure herein relates to a novel composition for simultaneous compensation of tolerances and for sealing, especially for use in aircraft, especially in commercial aircraft.

### BACKGROUND

Modern methods of lightweight construction have brought significant changes in the recent past to construction of vehicles, whether they are ships, aircraft, automobiles or rail vehicles. Thus, the use of suitable materials leads to improvements in terms of weight, safety and comfort.

Therefore, components made from carbon fiber-reinforced plastic (CFRP) are increasingly being used in aircraft construction. Such components are subject to tolerances to a high degree and therefore have to be processed prior to assembly with materials for gap closure, known as shimming, and sealants. Accordingly, a multitude of holes and rivets are introduced into the components in order to fix them to one another.

Means of compensating for tolerances (shimming) are compensation materials for achievement of a defined thickness of a component. They fill gaps, may be in liquid, curable form, and are stiff and rigid after curing. The shim materials are generally 2-component epoxy resins that have a gap-filling capacity of about 2-3 mm and a curing time of 8 h at room temperature. Larger gaps are made up manually in a time-consuming manner by solid shims made of fiber composite material. It is also possible to use a combination of liquid and solid shim materials. Overall, the processing of the shim materials is essentially manual and is highly time-consuming, especially since the joining partners, for determination of the gap dimensions, have to be temporarily joined and then the joining partners have to be parted again for the execution of the further process steps. Sealants serve to prevent the penetration of unwanted media, for instance moisture, and have a certain elasticity and flexibility. It is therefore impossible to use the composition for tolerance compensation simultaneously as sealant: prior to the final assembly of a component treated with a composition for tolerance compensation, an additional intervening layer of sealant is often required. Such components are often processed further by drilling and riveting, for which neither the composition for tolerance compensation nor the sealant as structural adhesive are suitable.

There was a lack of a material which is firm enough to fill gaps, flexible enough to ensure leaktightness and additionally can absorb any forces in order to assure rivetless structural adhesive bonding.

### SUMMARY

A curable material is disclosed herein for simultaneous filling of tolerances and for sealing of components to be bonded in aircraft construction. The curable material can be made of fiber-reinforced plastic (CFRP). The curable material enables simultaneous structural adhesive bonding. The curable material can be based on two-component epoxy resin.

### BRIEF DESCRIPTION OF THE DRAWINGS

In the figures, identical reference numerals are used for identical or at least similar elements, components or aspects. It should be noted that there follows a detailed description of embodiments that are merely illustrative and not restrictive.

FIG. 1 shows two components between which there is a tolerance-related gap.

FIG. 2 shows two components, the mutually facing surfaces of which are activated. This can be effected physically (e.g. grinding, corona) or chemically (e.g. etching).

FIG. 3 shows two components, the mutually facing surfaces of which are cleaned.

FIG. 4 shows two components, with a composition according to the disclosure herein positioned in the tolerance-related gap between them.

FIG. 5 shows two components bonded by composition according to the disclosure herein.

### DETAILED DESCRIPTION

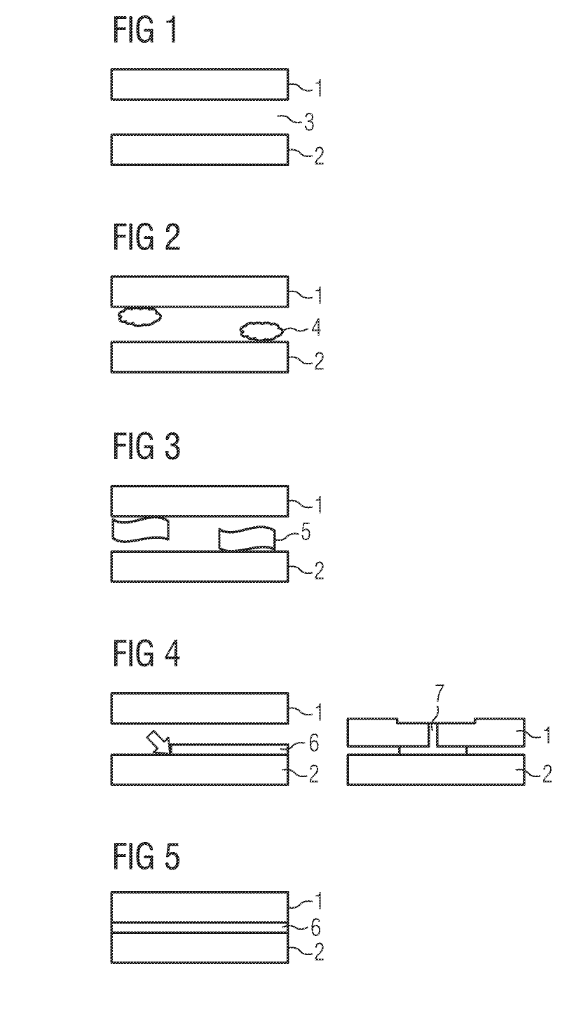

FIG. 1 shows two components (1) and (2) between which there is a tolerance-related gap (3).

FIG. 2 shows two components (1) and (2), the mutually facing surfaces of which are activated (4). This can be effected physically (e.g. grinding, corona) or chemically (e.g. etching).

FIG. 3 shows two components (1) and (2), the mutually facing surfaces of which are cleaned (5).

FIG. 4 shows two components (1) and (2), with a composition (6) according to the disclosure herein positioned in the tolerance-related gap (3) between them. This is a 2-component epoxy resin which, after curing, has a modulus of elasticity dependent on shear stress. In a further embodiment, the composition (7) according to the disclosure herein is injected between two abutting components (1) in order to fill and to seal both the vertical gap between the two components (1) and the gap between the components (1) and (2).

FIG. 5 shows two components (1) and (2) bonded by composition (6) according to the disclosure herein

In a manner completely surprising to the person skilled in the art, it has been found that a curable material for simultaneous filling of tolerances and for sealing of components to be bonded in aircraft construction remedies the disadvantages of the prior art. It is preferable here that the components to be bonded in aircraft construction consist of or comprise fiber-reinforced plastic (CFRP). It is preferable here that the material simultaneously enables structural adhesive bonding. It is preferable here that the material is formulated on the basis of two-component epoxy resin. It is preferable here that the modulus of elasticity thereof has nonlinear dependence on shear stress and deflection. Modulus of elasticity:

$$E = \frac{σ}{ɛ} with σ = tension , ɛ = elongatio$$

It is preferable here that the material has a modulus of elasticity that obeys the formula:

$$E ( t ) = \frac{σ ( t )}{ɛ}$$

$$with σ = shear stress , ɛ = deflection and t = time .$$

This means that the material has a high modulus of elasticity under an abrupt significant impulse, and a low modulus of elasticity under the influence of normal impulses that act over comparatively longer periods.

It is preferable here that the material is drillable. It is preferable here that the material has tack in order to hold the bonded components together firmly but flexibly with respect to one another. It is preferable here that it is curable at −55° C. to 120° C., preferably below 90° C.

The above-described aspects and further aspects, features and advantages of the disclosure herein can likewise be inferred from the examples of the embodiments that are described hereinafter with reference to the appended drawings.

While the disclosure herein has been illustrated and described in detail in the drawings and the preceding description, the intention is that such illustrations and descriptions are merely illustrative or exemplary and not restrictive, such that the disclosure herein is not restricted by the embodiments disclosed. In the claims, the word “having” does not exclude other elements and the indefinite article “a” does not exclude a multitude.

Merely the fact that particular features are mentioned in different dependent claims does not restrict the subject-matter of the disclosure herein. Combinations of these features can also be used advantageously. The reference numerals in the claims are not intended to restrict the scope of the claims.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE NUMERALS

1 component
2 component
3 gap
4 means of activating the surfaces
5 means of cleaning the surfaces
6 composition according to the invention
7 injection of composition according to the invention

1. A curable material for simultaneous filling of tolerances and for sealing of components to be bonded in aircraft construction.

2. The curable material according to claim 1, made of fiber-reinforced plastic (CFRP).

3. The curable material according to claim 1, wherein the curable material enables simultaneous structural adhesive bonding.

4. The curable material according to claim 1, based on two-component epoxy resin.

5. The curable material according to claim 1, having a modulus of elasticity having nonlinear dependence on shear stress and deflection.

6. The curable material according to claim 1, having a modulus of elasticity represented by:
$$E ( t ) = \frac{σ ( t )}{ɛ}$$
$$with σ = shear stress , ɛ = deflection and t = time .$$

7. The curable material according to claim 1, wherein the curable material is drillable.

8. The curable material according to claim 1, having tack in order to hold bonded components together firmly but flexibly with respect to one another.

9. The curable material according to claim 1, having curability at −55° C. to 120° C.

10. The curable material according to claim 9, having curability below 90° C.
